(19) United States
(12) Patent Application Publication
(10) Pub. No.: US 2025/0050563 A1
(43) Pub. Date: Feb. 13, 2025

(54) PRODUCTION METHOD FOR AN OBJECT HAVING A MICROSTRUCTURE, MATERIAL AND USE OF THE MATERIAL

(71) Applicant: Hilti Aktiengesellschaft, Schaan (LI)

(72) Inventors: Andreas SPOMER, Koeln (DE); Daniel SELTMANN, Landsberg am Lech (DE); Maximilian KUMMER, Ulm (DE)

(21) Appl. No.: 18/722,612

(22) PCT Filed: Jan. 10, 2023
(86) PCT No.: PCT/EP2023/050432

§ 371 Date: Jun. 21, 2024

(30) Foreign Application Priority Data
Jan. 11, 2022 (EP) 22150934.2

(51) Int. Cl. B29C 45/37; B29C 33/42; B29C 45/00; B29K 21/00

(52) U.S. Cl. CPC B29C 45/372; B29C 33/424; B29C 2045/0094; B29K 2021/003

(57) ABSTRACT

A method for producing an object having a microstructure. In the production of the objects, use is made of injection molds which have a counterstructure to the desired microstructure of the object, wherein the counterstructure of the injection mold can be obtained by laser structuring. The material and the objects produced therefrom have proven to be surprisingly robust, hard-wearing and slip-resistant, making them particularly suitable for the production of handles for power tools. A material which includes at least one thermoplastic elastomer material, wherein a texture depth of the material is in a range of from 250 to 400 μm, preferably in a range of from 300 to 380 μm, and more preferably about 325 μm. In yet another aspect, the invention relates to use of the material as a surface material for power tools.

### BACKGROUND OF THE INVENTION

The present invention relates to a method for producing an object having a microstructure. In the production of the objects, use is made of injection molds which have a counterstructure to the desired microstructure of the object. In yet another aspect, the invention relates to use of the material as a surface material for power tools.

### SUMMARY OF THE INVENTION

Power tools having handles are known in the prior art. The handles of the power tool are often made of plastics, and these easily become dirty, are not very robust, do not sit well in the hand or slip easily out of the hand of the user, for example. Such handles can therefore pose a safety risk or make working with the power tool seem less than comfortable or pleasant.

An object on which the present invention is based is that of overcoming the above-described defects and disadvantages of the prior art and of indicating an improved material for use in the field of power tools which is particularly safe, pleasant to the touch and user-friendly.

According to the invention, a material is provided, wherein the material comprises thermoplastic elastomers. The material is characterized in that a texture depth of the material is in a range of from 250 to 400 μm. In a preferred embodiment of the invention, the texture depth of the material can be in a range of from 300 to 380 μm. It is even more preferred that the texture depth of the material is about 325 μm. For the purposes of the invention, it is preferred that the material is produced by injection molding, wherein, in particular, laser-structured injection molds can be used. In the production of the material, use is preferably made of injection molds in which the hills have a height of, for example, 225 μm or the dales have a depth of 225 μm, these injection molds advantageously leading to the material having a texture depth of about 325 μm. For the purposes of the invention, the height difference or distance between the hills and dales of the injection mold is preferably about 450 μm. A roughness depth of the injection mold can be in a range of from 400 to 500 μm, preferably in a range of from 425 to 475 μm, and more preferably 450 μm.

For the purposes of the invention, it is preferred that the obtained texture depth of the material is less than the height of the hills and/or dales of the injection molds which are used to produce the material. Tests have shown that the material having the texture stated can be demolded surprisingly well, thus enabling the production method to be carried out easily and ensuring that it produces particularly little unusable waste material. For the purposes of the invention, it is preferred that the hills of the injection molds form the dales on the surface of the objects produced by the method, while the dales of the injection molds form the hills on the surface of the objects produced by the method. In this case, the microstructures (the hills and dales) on the surface of the objects produced are preferably about 55 to 90% of the height or depth of the structures in the injection mold. The injection mold is preferably produced by laser structuring. For the purposes of the invention, this preferably means that, in particular, the hills and dales in the injection mold, which later form the microstructure on the surface of the objects produced, are produced by laser structuring. It is preferred for the purposes of the invention that the injection mold is also referred to as “tools”.

It was surprising that the injection molded objects can be removed from the injection molds so well without damage to the objects occurring. This was all the more surprising because the hills and dales of the injection molded objects project from one plane of the material by up to 200 μm, for example. The hills and dales on the object produced, which can be a handle for a power tool for example, preferably form a microstructure, wherein the highest points project by up to 200 μm from a center plane of the object. In particular, it was surprising that the microstructure produced by the injection molding method can be removed from the injection mold transversely to the direction of a bumpoff with, surprisingly, little or no damage or scratch marks being observed in the objects produced in this way. In other words, it was completely surprising that the bumpoff of the objects produced can take place in such a damage-free way even though individual components of the microstructure of the object produced project from the material by up to 200 μm. It is a significant advantage of the invention that, with the aid of the combination of the texture depth of the microstructure according to the invention with the thermoplastic elastomer used as the base material, it is possible to enable such damage-free and uncomplicated bumpoff of the injection-molded objects produced. The injection molded objects produced have microstructures, in particular transversely to the demolding direction, it being possible for these microstructures to be removed from the injection mold in a particularly damage-free manner.

For the purposes of the invention, it is preferred that a ratio between the texture depth T of the microstructure, which—as will be explained further below—can also be referred to as the roughness depth Rz of the microstructure, and a hill and dale distance of the injection mold can be in a range of from 0.55 to 0.90, preferably in a range of from 0.65 to 0.85, and particularly preferably 0.72. In other words, it is preferred for the purposes of the invention that the roughness depth Rz or texture depth T of the microstructure is less than the roughness depth of the tool, i.e. the injection mold. It has been found that objects with a microstructure according to the invention with such a ratio of roughness or texture depth to the roughness depth of the injection mold can be demolded, i.e. released from the mold, particularly well. As a result, the production method can be carried out in a surprisingly simple manner and it is possible to operate in a way which is particularly sparing of resources.

A further surprise is that the material used for injection molding reproduces the hills and dales which are introduced into the preferably laser-structured injection mold so well, even though individual components of the microstructure of the preferably laser-structured injection mold project by up to 200 μm into the material of the injection mold and thus form up to 200 μm dales of the microstructure. The, for example, 225 μm deep dales in the injection mold then subsequently preferably produce the hills with a height of up to 200 μm on the surface of the objects produced by the method. Those skilled in the art have hitherto assumed that such deep structures in the injection mold form dead ends for trapped air and thus also for the injection molding material used. It was therefore surprising that this is not so in the present case owing to the thermoplastic elastomer material and the depth of the injection mold of, for example, 225 μm, and that the material fills and reproduces the hills and dales of the injection mold particularly well. For example, a ratio can be formed between the height or depth of the individual microstructures which are produced in the thermoplastic material by the production method and the tool, i.e. the injection mold, wherein this ratio can be, for example, 72%. For the purposes of the invention, this preferably means that 72% of the thermoplastic elastomer material penetrates into the injection mold and fills the laser-structured structures of the injection mold.

The microstructures produced by the production method preferably have grain sizes in a range of from 100 to 140 μm. In other words, the production method makes it possible to produce hills and dales which can be described by a diameter in a range of from 100 to 140 μm in a plan view of the material. A person skilled in the art understands that this is not a diameter for the description of a mathematically exact circle but that the grains which can be produced by the production method are objects which can be well described by structures similar to circles in a plan view and are therefore best characterized by a diameter.

For the purposes of the invention, it is preferred for the material to comprise a base material which can comprise the plastic materials polyolefin, polyamide, styrene copolymers, polyester and polyurethane. For the purposes of the invention, it is preferred that the base material of the material comprises TPE materials, i.e. thermoplastic elastomers. For example, the base material can also comprise polyurethane, wherein, in particular, mixtures of different types of plastic may also be preferred in order to provide the base material. For the purposes of the invention, it is very particularly preferred that soft injection materials are used, i.e. plastic materials which can be used for injection molding.

The material has a surface texture whose properties are determined, in particular, by the height differences between the highest and the lowest regions of the material. For the purposes of the invention, the distance between these highest and lowest regions of the material is preferably referred to as “texture depth”. In other words, the material can comprise “hills” as the highest points and “dales” as the lowest points, wherein a height difference between the highest and the lowest points is in a range of from 250 to 400 μm, preferably in a range of from 300 to 380 μm, and more preferably 325 μm. For the purposes of the invention, the height differences between the hills and dales of the material are preferably referred to as “texture depth”. The height of the individual hills and dales with respect to an imaginary center plane of the material is preferably in a range of from 125 to 200 μm, preferably in a range of from 150 to 190 μm, and more preferably in a range of from 160 to 165 μm.

For the purposes of the invention, it is preferred that the hills and the dales of the material are produced in a targeted manner by means of lasers of the tool or injection molds, as a result of which, in conjunction with the injection molding method, the texture depth of the material in a range of approximately 325 μm is obtained. The objects produced can be obtained, in particular, by an injection molding method, it being possible for the injection molds used in this method or the structuring thereof to be obtained by laser structuring. Consequently, the objects produced, which can be, for example, handles for power tools, are advantageously produced by a combination of the “injection molding” production method and laser structuring of the injection molds used for this purpose.

The material which can be produced by the production method described below and has a texture depth in a range of from 250 to 400 μm feels surprisingly soft and sits well in the hand of a user. Tests have shown that, despite the harsh environment and the usual working conditions on a construction site, the micromaterial is perceived as pleasing to hold, and therefore power tools provided with the material are perceived as particularly high-quality and pleasant to handle. Moreover, the material has proven to be surprisingly slip-resistant. This latter property improves the grip with which the user holds the power tool and can represent a significant safety feature of a power tool coated with the material. The risk of loss of control over the power tool can be considerably reduced by the use of the material and the operational safety can be significantly increased in this way.

In a second aspect, the invention relates to use of the material as a surface material for power tools. For the purposes of the invention, it is preferred that the material is used as a surface material, for example for a handle of the power tool. In the production of the handles, which, for the purposes of the invention, are also referred to abstractly as “objects”, hollow parts made of steel are preferably used as injection molds, wherein the injection molds are laser-structured. This means, in other words, that the hills and dales in the injection mold, which subsequently form the dales and hills of the material produced or on the surface of the objects produced, are introduced into the injection molds by laser structuring.

For the purposes of the invention, it is preferred that the injection molds have a roughness depth of about 450 μm. For the purposes of the invention, this preferably means that, for example, the dales in the injection mold have a depth of up to 225 μm. The objects or handles are then produced with the aid of the preferably laser-structured injection molds. They comprise at least one thermoplastic elastomer material, wherein the objects produced have a texture depth in a range of from 250 to 400 μm. The surface of the objects produced is formed by a microstructure which can have dales and hills. For the purposes of the invention, the term “power tool” is to be understood broadly. In particular, the term refers to conventional power tools such as, for example, screwdrivers, cut-off or cutting devices, grinders, saws, chisels, core drills and simple drills and/or setting tools, without being restricted thereto. However, the term “power tool” preferably also encompasses auxiliary devices, such as, for example, vacuum cleaners, water management or recycling devices, feed devices or external control devices, without being restricted thereto. Moreover, the handle can have any conceivable shape, i.e. can be C-shaped, T-shaped or D-shaped. Of course, the handle, which is at least partially covered with the material, may also be rod-shaped and/or protrude from a housing of the power tool.

For the purposes of the invention, it is preferred that the microstructure can also be assigned a roughness depth. For example, the microstructure can comprise essentially alternating, i.e. adjacent, high plateaus and lower-lying regions, which are preferably referred to as “hills” and “dales” for the purposes of the invention. These high plateaus and lower-lying regions can represent the circular structures described above, which can be characterized with a diameter and have a grain size of 100 to 140 μm. In a sectional representation of the microstructure, the high plateaus and lower-lying regions can be visualized as alternating hills and dales. The roughness depth of the microstructure can then be designated by the letter combination “Rz”, for example, it being possible for the roughness depth Rz of the microstructure to be defined as the mean hill/dale distance in a series of hill and dale sequences. If, for example, five successive regions, each comprising a hill and a dale, are examined in a sectional representation of the microstructure, a distance between the hill and the dale of the respective region can be determined for each of the, for example, five regions. The distances thus determined can then be averaged, the distance between the hill and the dale averaged over, for example, five regions being referred to as the (mean) roughness depth Rz of the microstructure. In an alternative formulation, this averaged distance between hills and dales can be referred to as “mean hill/dale distance in a series of hill and dale sequences”. Thus, the roughness depth Rz of the microstructure preferably represents the maximum height of the profile of the microstructure, where the roughness depth Rz of the microstructure is preferably determined as a mean value of hill and dale height differences in, for example, five successive regions of a sectional representation of the microstructure. If the hill and dale height difference in a number of “i” successive regions is referred to as Rz_i, the index “i” representing the first, second or further region, the roughness depth Rz of the microstructure can be obtained as the mean value of the values Rz_i. If, for example, five successive hill and dale height differences are used to determine the roughness depth Rz of the microstructure, the mean value of the values Rz_1 to Rz_5 can be formed, which then advantageously gives the roughness depth Rz of the microstructure.

For the purposes of the invention, it is preferred that the texture depth T of the microstructure can be equated with the roughness depth Rz of the microstructure, wherein a texture depth T and/or a roughness depth Rz of the material or microstructure is in a range of from 250 to 400 μm. For the purposes of the invention, it is very particularly preferred that the texture depth T and/or the roughness depth Rz of the material or microstructure is in a range of from 300 to 380 μm. Particular preference is given to values for the texture depth T and/or the roughness depth Rz of the material or microstructure of approximately 325 μm.

The material, which can be produced from a base material having at least one thermoplastic elastomer and has a texture depth in a range of from 250 to 400 μm, can be used to particular advantage in the power tool sector, in particular in the region of the handles, since it is surprisingly hard-wearing and robust. Even under heavy use, the material remains intact and retains its user-friendly and skin-friendly properties. Application tests have shown that the material is particularly neutral to allergies and is also available with antistatic properties. As a result, the component of the power tool which is coated with the material is not or is hardly electrostatically charged, and unwanted electrical discharges, which can be unpleasant for the user, are considerably reduced. In addition, the material is particularly easy to clean since any contamination can be removed surprisingly well from the particularly deep dales and from the particularly high hills of the material. Contrary to the expectations of those skilled in the art, the particularly deep dales are very easily accessible, enabling dust and other dirt to be removed particularly easily from the surface of the material.

A further advantage in the use of the material in the power tool sector is that it is particularly light, and it is therefore possible to provide a comparatively light power tool with the material.

In another aspect, the invention relates to a method for producing an object having a microstructure, wherein the method is characterized by the following method steps:
a) providing a base material for producing the object, wherein the base material comprises at least one thermoplastic elastomer,
b) providing injection molds for the production of the object, wherein the injection mold has a counterstructure to the microstructure of the object,
c) injection molding the object, wherein the microstructure of the object is produced by the counterstructure of the injection mold.

For the purposes of the invention, it is preferred that the individual components of the counterstructure of the injection mold are approximately twice as high or deep as the components of the microstructure of the object. The injection molds can have a roughness depth of 450 μm, for example, wherein the height and depth of the hills and dales of the microstructure of the object can be between 160 and 165 μm, for example. The term “counterstructure” means that the dales of the microstructure of the object are formed from the hills of the surface structure of the injection molds, while the hills of the microstructure of the object produced are formed from the dales of the surface structure of the injection molds. For the purposes of the invention, it is preferred that a texture depth of the microstructure is in a range of from 250 to 400 μm. For example, the hills and dales of the surface of the object produced can have a height or depth of between 160 and 165 μm.

For the purposes of the invention, it is preferred that the surface structure of the injection molds, that is to say the counterstructure, is created by means of laser structuring. In other words, the injection molds or the injection molding tools can be produced by a preferably upstream method step of laser structuring. For the purposes of the invention, this preferably means that, in particular, the counterstructure of the injection molds is produced using a laser.

The invention also relates, in particular, to all objects, devices and/or device parts which can be produced by the production methods described.

The processing of the material in the power tool sector has proven to be particularly advantageous since the material can surprisingly be processed in a particularly material-saving manner without great losses, even though, for example, the handle of a power tool can have a complex external shape. The material satisfies these particular challenges in a particularly suitable manner. The good processability of the material is due, in particular, to the surprisingly good elasticity of the material, which is achieved, in particular, by the material mix of the underlying base material and the texture depth in the range of from 250 to 400 μm.

The terms, definitions and technical advantages introduced for the material apply analogously to the use of the material in the power tool sector and to the production method.

If the material is used in the region of a handle of a power tool, it may be preferred for the purposes of the invention that the handle of the power tool has zones with different heights and depths of the hills and dales of the material. In other words, zones with different roughnesses can be used in the region of a handle in order to fulfill different functions or requirements. It has been found that the material with a comparatively high roughness, for example with a texture depth of 400 μm, ensures greater friction between the power tool and the hand of the user than a material with a lower roughness or texture depth, for example in a range of 250 μm. Based on this knowledge, it is possible to develop handles for power tools which have zones with different roughnesses or texture depths, these roughnesses and/or texture depths of the material being adapted to the respective requirements of the respective handle region.

If the handle of the power tool is designed, for example, as a C or D handle, the handle can have a zone with a particularly high roughness and/or texture depth in its central region. The central region of a handle of a power tool shaped in this way often extends substantially parallel to an edge or a side surface of the power tool or its main body. The handle of the power tool is preferably gripped by the hand of a user in this central region, and therefore a high friction is preferably demanded in this region. The invention can provide this high friction by a handle for a power tool having a central region, the central region of the handle having a roughness and/or texture depth which is greater than a roughness and/or texture depth of the surrounding regions. For example, the regions of the handle which open into the power tool or its main body can have a roughness and/or texture depth which is less than the roughness and/or texture depth of the central region of the handle of the power tool.

It was completely surprising that with the production method it is also possible to produce handles on which the roughness and/or texture depth changes within a zone. For example, the roughnesses and/or texture depths within a zone can increase or decrease substantially continuously, making it possible to achieve a “fading effect”, i.e. a fade-in or fade-out effect. In such a zone, the roughness, roughness depth and/or texture depth can, for example, pass substantially continuously through the range of the texture depth of 250 to 400 μm according to the invention. Of course, it is also possible for the increasing or decreasing texture depth to pass through only a partial range of the texture depth of 250 to 400 μm according to the invention. For example, the roughness and/or texture depth can have a maximum roughness and/or texture depth of approximately 400 μm in a central region of a power tool handle, which is preferably designed as a C or D handle, while the central region of the handle is adjoined by zones with decreasing roughness and/or texture depth, in which the roughness, roughness depth and/or texture depth in the boundary region with respect to the central region is, for example, approximately 300 μm and, at the opposite end of the zone, is approximately 250 μm. For the purposes of the invention, it is very particularly preferred that the roughnesses, roughness depths and/or texture depths can be adapted to the intended functionality of the corresponding handle region. In other words, handle regions in which a high friction is required can have a comparatively large roughness and/or texture depth, while other handle regions, in which a low friction is required because, for example, changes in position or a gripping around frequently occur, have a comparatively low roughness and/or texture depth.

Thus, in the context of the present invention, a handle for a power tool is also disclosed, which can have a C-shape or a D-shape, for example. The handle can be characterized in that it has zones with different roughnesses and/or texture depths. In addition, it may be preferred in this aspect of the invention that the roughness and/or texture depth in such a zone increases or decreases substantially continuously. By means of these last-mentioned features, the properties of the handle, in particular its roughness and/or texture depth, can be adapted to a desired functionality of the corresponding region or zone of the handle.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures,
where:

FIG. 1 shows a view of a preferred embodiment of a handle of a power tool comprising the material; and

FIG. 2 shows a schematic view of a preferred embodiment of the surface structure of the material.

### DETAILED DESCRIPTION OF EXEMPLARY EMBODIMENTS

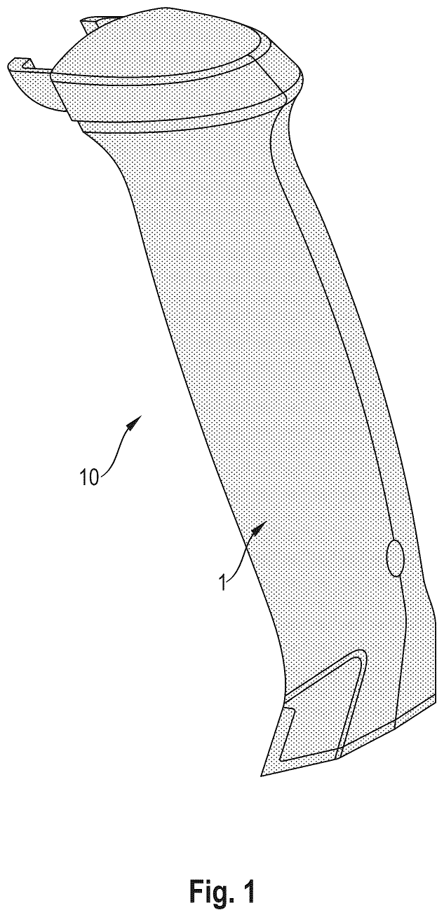

FIG. 1 shows a preferred embodiment of a handle (10) of a power tool (not shown). The surface of the handle (10) comprises the material (1), wherein a texture depth (T) of the material (1) is in a range of from 250 to 400 μm, preferably in a range of from 300 to 380 μm, and more preferably substantially 325 μm. The term “substantially” is not an unclear term for a person skilled in the art; on the contrary, a person skilled in the art knows that minor deviations from an exact height or depth of the hills (4) or dales (5) of the material (1) can result, for example, from production conditions. The term “substantially” is intended to include such minor deviations of, for example, +/−3 μm. The hills (4) or dales (5) preferably form a microstructure, which can form the surface of the handle (10) of a power tool. For the purposes of the invention, it is preferred if the microstructure of the power tool handle (10) has a texture depth (T) in a range of from 250 to 400 μm, preferably in a range of from 300 to 380 μm, and more preferably 325 μm.

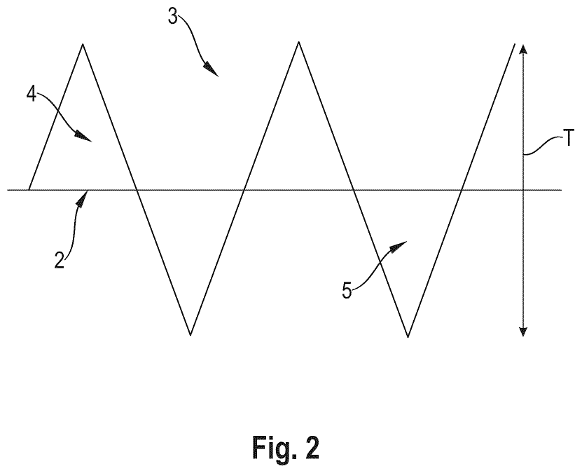

A schematic example of a preferred embodiment of the surface structure (3) of the material (1) is shown in FIG. 2. This shows the imaginary center plane (2) from which the height of the hills (4) and the depth of the dales (5) of the surface of the material (1) are determined. The height of these hills (4) and the depth of these dales (5) preferably determine the texture depth (T) of the material (1). In particular, the texture depth (T) represents the distance or the height difference between the peaks of the hills (4) and the lowest points of the dales (5).

The imaginary center plane (2) can be considered to be the average of all the heights and depths, i.e. of all the surface structures of the material (1). The imaginary center plane (2) is thus preferably located halfway between the peaks and the pits of the surface of the material (1). FIG. 2 shows a highly schematized representation of a possible surface structure (3) of the material (1), which is intended, in particular, to clarify the terms “hills”, “dales” and “texture depth”. In particular, the surface illustrated schematically in FIG. 2 can form a surface of a handle (10) of a power tool. It can also form the surface of any object produced by the production method.

### LIST OF REFERENCE SIGNS

1 Material
2 Imaginary center plane
3 Surface structure
4 Hills
5 Dales
10 Handle of a power tool
T Texture depth

What is claimed is:

1-11. (canceled)

12: A method for producing an object having a microstructure, the method comprising the following steps:
a) providing a base material for producing the object, wherein the base material includes at least one thermoplastic elastomer;
b) providing injection molds for production of the object, wherein the injection mold has a counterstructure to the microstructure of the object; and
c) injection molding the object, wherein the microstructure of the object is produced by the counterstructure of the injection mold.

13: The method as recited in claim 12 wherein a roughness depth of the injection mold is in a range of from 400 to 500 μm.

14: The method as recited in claim 12 wherein a roughness depth of the injection mold is in a range of from 425 to 475 μm.

15: The method as recited in claim 12 wherein a roughness depth of the injection mold is 450 μm.

16: The method as recited in claim 12 wherein the counterstructure of the injection mold is obtained by laser structuring.

17: The method as recited in claim 12 wherein the microstructure of the object has a texture depth in a range of from 250 to 400 μm.

18: The method as recited in claim 12 wherein the microstructure of the object has a texture depth in a range of from 300 to 380 μm.

19: The method as recited in claim 12 wherein the microstructure of the object has a texture depth of 325 μm.

20: The method as recited in claim 12 wherein a ratio between a texture depth of the microstructure and a roughness depth of the injection mold is in a range of from 0.55 to 0.90.

21: The method as recited in claim 12 wherein a ratio between a texture depth of the microstructure and a roughness depth of the injection mold is in a range of from 0.65 to 0.85.

22: The method as recited in claim 12 wherein a ratio between a texture depth of the microstructure and a roughness depth of the injection mold is 0.72.

23: A material producible using the method as recited in claim 12, the material comprising: at least one thermoplastic elastomer, a texture depth of the material being in a range of from 250 to 400 μm.

24: The material as recited in claim 23 wherein the texture depth of the material is in a range of from 300 to 380 μm.

25: The material as recited in claim 23 wherein the texture depth of the material is 325 μm.

26: The material as recited in claim 23 wherein the material has a a microstructure with the texture depth.

27: A surface material for power tools comprising the material as recited in claim 23.

28: A handle of a power tool comprising the material as recited in claim 23.
